(19) United States
(12) Patent Application Publication
(10) Pub. No.: US 2007/0184736 A1
(43) Pub. Date: Aug. 9, 2007

(54) FILAMENT-REINFORCED ADHESIVE TAPE

(75) Inventors: KARSTEN SEITZ, BUXTEHUDE (DE); HENNING LATZ, LUNEBURG (DE); ULRICH OTTEN, HAMBURG (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AKTIENGESELLSCHAFT, HAMBURG (DE)

(21) Appl. No.: 11/671,667

(22) Filed: Feb. 6, 2007

(30) Foreign Application Priority Data
Feb. 7, 2006 (DE) 20 2006 002 019.5
May 19, 2006 (DE) 10 2006 023 935.0

(51) Int. Cl. B32B 5/02; B32B 7/12

(52) U.S. Cl. 442/151; 428/343

(57) ABSTRACT

Adhesive tape having a backing material applied to at least one side of which is an adhesive and whose strength in lengthwise direction is reinforced by integrated or added fibers or filaments, characterized in that the adhesive tape on at least one long edge has incisions, the incisions severing per long edge at least one filament aligned substantially parallel to the cut edge.

The invention relates to a filament-reinforced adhesive tape.

In connection with the processing of fabrics it has been known for a long time that individual fibers can be prevented from pulling out by cutting the fabric not linearly but instead in zigzag form. As a result of this, the threads parallel to the cut edge are severed transversely at regular intervals and cannot be extracted in a longer piece. Short thread fragments that fall out tend to disrupt subsequent processing to a significantly lesser extent than do long threads, and are therefore accepted. It is for this reason that the literature has disclosed numerous devices which produce such serrations. Another method of preventing fiber pullout is to carry out thermal welding of the fabric during or after cutting. However, this can be utilized only with thermoplastic materials such as polyester, nylon or polypropylene, but not, for example, with natural fibers, glass or aramid fibers.

However, where fabrics are fixed by means of coating, impregnation, or thermally, the risk of fiber pullout no longer exists, or only to an insignificant extent, and so countermeasures such as serration are not practiced.

As well as for preventing fiber pullout, serration may likewise be utilized with advantage in order to improve the hand tearability of fabrics. The majority of fabrics resist attempts to tear into them by hand, owing to the strength of the individual fibers and the fabric's flexibility, to such an extent that tearing in at a straight cut edge by hand is well-nigh impossible or can be achieved only with great effort. Since, however, this hand tearability is desirable in the case of frequent use of, for example, plasters in roll form or pressure-sensitive adhesive tapes, in order to facilitate handling, serration can be employed with advantage here as well. In this case the tear typically starts from the inner corner of a zigzag cut-out pointing in the direction of the middle of the adhesive tape. Once it has been begun, the tear can usually be continued without great effort in dense fabrics, parallel to warp or weft depending on the direction of cut.

This technique for achieving hand tearability in fabrics has the disadvantage, however, that the tensile strength of such a material is greatly reduced. The reason for this is that, under high load, the start of tears, as described, is favored at the inner corners of the cut-outs, and the force for continuation of the tear (tear propagation force) is substantially lower than the force needed to generate a tear at the fabric edge or in the fabric (in-tear force). In many cases this disadvantage can be accepted, as in the case, for example, of the roll plasters mentioned above.

With film-based materials as well, serration may be employed with advantage for the same reasons—as, for example, in the case of double-sided adhesive tapes for fixing carpets. DE 43 18 277 C1 discloses the use of serrated knives for lengthwise cutting of double-sided self-adhesive tapes with PP backings, which find use in particular as carpetlaying tape. The serrations of the serrated cutter preferably have a height of 0.3 to 6 mm, especially 0.4 to 1 mm. The resultant serrature of the cut edge increases the hand tearability of the adhesive tape.

Backings used in the area of (self-)adhesive tapes include not only those materials based on polymeric films and paper but also those based on woven and nonwoven fabrics. The area of the woven fabrics also encompasses, in a wider sense, fabrics which, in the form of what are called filament adhesive tapes, comprise a backing material which is composed of an optional support film and of non-folded and non-tangled or folded or tangled filaments integrated in the lengthwise direction, or else of an optional support film and an open, woven or laid fabric composed of non-folded and non-tangled or folded or tangled filaments. The filaments are generally composed of high-strength fibers of low breaking extension, such as glass fibers, for example, or else of possibly drawn polymer fibers such as polyester fibers, polypropylene fibers, polyethylene fibers, polyamide fibers or aramid fibers.

The risk of fiber pullout with these filament adhesive tapes is particularly great when the filaments used are located directly at the cut edge and are therefore severed in the lengthwise direction, and when the filaments, owing to the individual fibers lying parallel and close to one another in the filaments, are not fully impregnated by pressure-sensitive adhesive or other coatings. As a consequence, in the center of the filaments, individual fibers are often loose and unbonded, and, if the filament is severed in parallel of the cut edge, they can easily fall out, particularly when the filaments in question are neither spun nor folded nor tangled filaments.

The individual fibers which have fallen out may subsequently wind themselves easily around rotating shafts and other web guidance elements on continuous processing machines, and may ultimately lead to considerable cleaning cost and effort, adhesive tape tears, or even to production standstill. For economic reasons, this is unacceptable and would make the possibility of using filament adhesive tapes of this kind in continuous operations very difficult or even rule it out.

At the same time, when searching for measures to counter the above-described fiber pullout, it must be borne in mind that the said self-adhesive filament tapes are employed particularly when there is a need for particularly high tensile strength in tandem with particularly low stretchability. Therefore the tensile strength must be largely maintained under all circumstances. Nor is a reduction in the in-tear force or in the tear propagation force acceptable, since that would run counter to the purpose of the adhesive tape.

DE 102 23 631 A1 discloses an adhesive tape having a film backing material in which a tear can be propagated transversely with respect to the direction from which individual lengths of the tape are taken, an adhesive being applied to one side of said backing material, with an adhesive weight per unit area of at least 40 g/m², and there being on the other side, opposite the adhesive, a release, one or both longitudinal edges of the adhesive tape having notches over the entire area, with a width of less than 1000 μm and a depth of less than 100 μm, the notches being disposed irregularly and differing in depth. DE 102 23 632 A1 describes the use of an adhesive tape for masking during painting and decorating applications, having a film backing material in which a tear can be propagated transversely with respect to the direction from which individual lengths of the tape are taken, on one side of said backing material an adhesive has been applied, the adhesive tape being colored and/or non-transparent and one or both longitudinal edges of the adhesive tape having over the entire area notches having a width of less than 1000 μm and a depth of less than 100 μm, the notches being irregularly disposed and of differing depth.

DE 102 23 634 A1 discloses an adhesive tape having a film backing material in which a tear can be propagated transversely with respect to the direction from which individual lengths of the tape are taken, an adhesive being applied to one or both sides of said backing material, and one of the two longitudinal edges having a rough cut edge such that over the entire area there are notches in a frequency of at least 1/mm, the notches being disposed irregularly and differing in depth, and the other longitudinal edge being substantially smooth and having no such notches or a greatly reduced number thereof.

FR 1,522,942 A discloses a relevant adhesive tape one edge of which has microscopic notches.

It is an object of the invention, therefore, to avoid, on application and/or use, the pullout of disruptive fibers or filaments from adhesive tapes reinforced with the latter, without substantial reduction in tensile strength.

This object is achieved by means of an adhesive tape as described hereinbelow.

The invention accordingly provides an adhesive tape having a backing material applied to at least one side of which is an adhesive and whose strength in lengthwise direction is reinforced by integrated or added fibers or filaments, where the adhesive tape on at least one long edge has incisions, in particular a serration, the incisions or serration severing per long edge at least one filament aligned substantially parallel to the cut edge.

As used herein, the term “filament” refers to a bundle of individual, parallel, linear fibers, often referred to as multifilament in the literature. Where appropriate, this fiber bundle may be given inherent strengthening by torsion, and is then referred to as spun or folded filament. Alternatively the fiber bundle can be given inherent strengthening by entangling using compressed air or water jets. In the text below, for all these embodiments—and also for the fiber-reinforced embodiment—only the term “filament” will be used, in a general way.

Where the backing material is reinforced exclusively by filaments integrated/added in lengthwise direction, the resulting adhesive tapes are referred to as monofilament tapes. In one advantageous development of the subject matter of the invention the backing material is reinforced by an open filament fabric. In this case the adhesive tape is referred to as a cross-woven filament tape.

Suitable backing materials, that is to say materials which permit the specific application by combination with added or integrated filaments, include laminates, films (for example BOPP, MOPP, PP, PE, PET, PA, PU, PVC), foams, and foamed or metallized films. The films themselves may in turn be composed of two or more individual layers—for example, layers coextruded to a film.

Preference is given to polyolefins, although copolymers of ethylene and polar monomers such as styrene, vinyl acetate, methyl methacrylate, butyl acrylate or acrylic acid are also included. The polymer may be a homopolymer such as HDPE, LDPE, MDPE or a copolymer of ethylene with a further olefin such as propene, butene, hexene or octene (for example LLDPE, VLDPE). Also suitable are polypropylenes (for example polypropylene homopolymers, random polypropylene copolymers or block polypropylene copolymers).

The film may be unoriented.

Outstandingly suitable for use as films in accordance with the invention are monoaxially and biaxially oriented films. Monoaxially oriented polypropylene is notable for its very high breaking strength and low extension in lengthwise direction, and is used, for example, to produce strapping tapes.

Particular preference is given to films based on polyester or in particular polypropylene.

The combination of backing material with integrated or added filaments preferably has an extension of less than 10% under a load of 10 N/cm and also a basis weight of less than 350 g/m², preferably less than 200 g/m², more preferably less than 150 g/m².

With further preference the backing material with integrated or added filaments exhibits an ultimate tensile stress extension of below 25%, preferably below 15%, more preferably below 10%.

The backing material without filaments is usually up to 200 μm thick. In one particularly advantageous embodiment of the invention the backing material without filaments has a thickness of 10 to 100 μm, in particular of 20 to 40 μm.

The films may be colored and/or transparent.

The adhesive of the adhesive tapes of the invention may be a (self-)adhesive from the group of the natural rubbers or synthetic rubbers, or composed of any desired blend of natural rubbers and/or synthetic rubbers, it being possible for the natural rubber or rubbers to be selected in principle from all available grades such as, for example, crepe, RSS, ADS, TSR or CV grades, depending on required purity and viscosity level, and for the synthetic rubber or rubbers to be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible to improve the processing properties of the rubbers by adding thermoplastic elastomers with a weight fraction of 10% to 50% by weight, based on the total elastomer fraction. Representatives that may be mentioned at this point include in particular the especially compatible styrene-isoprene-styrene (SIS) and styrene-butadiene-styrene (SBS) grades.

In addition, a 100% system based on styrene-isoprene-styrene (SIS) has proved to be suitable.

Tackifying resins which can be used include without exception all tackifier resins already known and described in the literature. Representatives that may be mentioned include the rosins, their disproportionated, hydrogenated, polymerized and esterified derivatives and salts, the aliphatic and aromatic hydrocarbon resins, terpene resins and terpene-phenolic resins. Any desired combinations of these and further resins may be used in order to adjust the properties of the resultant adhesive in accordance with requirements. Explicit reference may be made to the depiction of the state of knowledge in the “Handbook of Pressure Sensitive Adhesive Technology” by Donatas Satas (van Nostrand, 1989).

Crosslinking is advantageous for improving the removability of the adhesive tape after the application, and may take place thermally or by irradiation with UV light or electron beams.

For the purpose of thermally induced chemical crosslinking it is possible to employ all known thermally activable chemical crosslinkers, such as accelerated sulfur or sulfur-donor systems, isocyanate systems, reactive melamine, formaldehyde and (optionally halogenated) phenol-formaldehyde resins and/or reactive phenolic resin systems or diisocyanate crosslinking systems with the corresponding activators, epoxidized polyester resins and acrylate resins, and also combinations of these.

The crosslinkers are activated preferably at temperatures above 50° C., in particular at temperatures of 100° C. to 160° C., very preferably at temperatures of 110° C. to 140° C. Thermal excitation of the crosslinkers may also take place by means of IR rays or high-energy alternating fields.

Adhesives based on solvent, on water or else as a hotmelt system can be used. An adhesive based on acrylate hotmelt is also suitable, it being possible for the latter to have a K value of at least 20, in particular more than 30, and obtainable by concentrating a solution of such an adhesive to give a system which can be processed as a hotmelt. Concentration may take place in appropriately equipped tanks or extruders; in the case of accompanying devolatilization, a devolatilizing extruder is particularly preferred. An adhesive of this kind is set out in DE 43 13 008 A1, whose content is hereby incorporated by reference to be part of this disclosure and invention. Alternatively the acrylate hotmelt-based adhesive can also be chemically crosslinked.

In a further embodiment the self-adhesives used are copolymers of (meth)acrylic acid and the esters thereof having 1 to 25 carbon atoms, maleic, fumaric and/or itaconic acid and/or their esters, substituted (meth)acrylamides, maleic anhydride and other vinyl compounds, such as vinyl esters, especially vinyl acetate, vinyl alcohols and/or vinyl ethers.

The residual solvent content should be below 1% by weight.

One adhesive which likewise proves to be suitable is a low molecular mass acrylate hotmelt pressure-sensitive adhesive of the kind carried under the name acResin UV or Acronal®, especially Acronal® DS 3458, by BASF. This low-K-value adhesive acquires its application-compatible properties by means of a concluding, radiation-induced chemical crosslinking.

Finally it may be mentioned that polyurethane-based adhesives are also suitable.

A single-sided adhesive tape can be used with particular advantage, the adhesive coatweight being preferably 30 to 100 g/m², more preferably between 60 to 80 g/m².

The backing material may additionally and preferably carry on its reverse face a release coating for improving the unwind. To increase the cohesion between the adhesive and the backing material or between the release coating and backing material, the backing material can be subjected to a corona treatment.

It is advantageous to use a primer layer between backing film and adhesive in order to enhance the adhesion of the adhesive to the film and hence to improve residue-free removability after the application.

Descriptions of the adhesives commonly used for adhesive tapes, and also of release coatings and primers, are found for example in the “Handbook of Pressure Sensitive Adhesive Technology” by Donatas Satas (van Nostrand, 1989).

The adhesive tapes have running lengths of 1000 to 30 000 m. Roll widths commonly selected are 10, 15, 19, 25 and 30 mm.

Filaments added to the backing material are high-strength fibers, folded yarns, folded union yarns or threads with low breaking extension.

The individual filaments are preferably continuous filaments and/or have a linear density of between 4 and 8 dtex, preferably 5 dtex. In one advantageous embodiment all of the filaments are continuous filaments.

In one preferred embodiment there are between 1 and 30 filaments per centimeter width in the backing material, in particular between 1 and 5.

It has proved to be advantageous additionally if the individual filaments are disposed regularly in one alignment parallel to the backing material or at most in three alignments parallel to the backing material. Within each alignment the filaments are disposed in parallel alongside one another.

The filaments may be composed of organic or inorganic materials: thus, for example and preferably, of glass, carbon, combinations of both fiber types, aramid fibers or special polyamides, or of drawn polymer fibers such as polyester fibers, polypropylene fibers, polyethylene fibers, and additionally the reinforcing fibers may be at least partly colored in order to make the backing material more visually appealing. In this way it is readily possible to provide visual differentiation of the reinforced backings. Particularly appropriate for this purpose are colored glass threads or polymer threads.

The backing material, further, is preferably laminated with the filaments. The filaments should be firmly connected to the backing material. This can be done by direct incorporation or insetting of the fibers, threads, folded yarns or folded union yarns into the backing, such as by weaving them in the case of wovens, knitting them in the case of knits, or embedding or inserting them in the case of the production process of films, gels or foam materials and nonwovens.

Alternatively the filaments can be connected subsequently to the backing; for example, mention may be made of their welding or lamination to a corresponding connection layer.

The number of attached or introduced threads and/or high-strength fibers depends primarily on the particular end use envisaged and on the target ultimate tensile stress strength and ultimate tensile stress extension of the backing material including fibers and hence of the adhesive tape, on its own nature, and on the respective strength of the fibers and threads themselves, and may therefore be varied within wide limits.

With increasing reinforcement, the backing withstands greater stress and load. Additionally, the reinforcements are preferably inserted purposively in accordance with the direction of stress on the backing material—that is primarily, in lengthwise direction.

However, if it is more appropriate, they can also extend additionally in transverse or oblique direction or, for example, in a curve, spiral or zigzag formation, or irregularly. In this context it may be desirable and achievable for the backing material to be able to be torn into by hand perpendicularly with respect to the orientation of the reinforcement and/or in the direction of the orientation.

In one advantageous embodiment of the subject matter of the invention the filament fabric reinforcing the backing material features the following combinations of properties:
100% of the filaments made from glass
Basis weight of the glass fabric 39 g/m²
Number of filaments running in lengthwise direction: 90/dm (measured in transverse direction)
Number of filaments running in transverse direction: 25/dm (measured in lengthwise direction)
   →Mesh: 1.11×4 mm
Tensile strength: 950 N/5 cm in lengthwise direction
   250 N/5 cm in transverse direction
Extension lengthwise and transversely 1.5% in each case

The fabric is combined with a base carrier made from BoPP having a thickness of 28 μm.

The profile of the cut edge of the adhesive tape is such that at defined intervals there are incisions in at least one of the two edges of the backing material. The intervals can be arbitrary and, if all of the incisions are directly adjacent to one another, the intervals are zero, i.e. are not present.

Each incision progresses, starting from a defined point, down to the lowest point, referred to as the minimum. The depth refers here to the orthogonal axis in the running direction of the adhesive tape, this axis extending from the side edge of the adhesive tape in the direction of the center line of the adhesive tape.

Subsequently the depth of the incision decreases again as it goes on, until the next turning point is reached and the depth increases again. This point represents a maximum. It is noted that, in the case of intervals between the incisions, the formation of the maxima is linear.

A maximum need not necessarily be identical with the point on the edge which, relative to the center of the backing, is at the greatest distance from the center of the backing; it is possible to combine incisions with different designs and also different depths, so that relative maxima may also occur.

Each incision is bounded by two maxima, with a minimum being located between these maxima.

In one advantageous embodiment of the invention, particularly in the case of a regular edge profile, all of the maxima and also all of the minima are situated on one straight line each, these straight lines being oriented parallel to the center of the backing in machine direction.

Each individual incision in the marginal region of the adhesive tape, i.e. on at least one of the lengthwise edges, has a defined depth T and also a defined breadth B. The depth T (see FIG. 4) extends from the outermost point of the incision to the lowest point in the incision. The breadth of the incision is defined as the distance between the two points that bound the incision, in other words the distance between two maxima in the profile of the cut edge.

The incisions on at least one long edge may be disposed irregularly. The incisions may be at a distance from one another or immediately behind one another. It is also possible, however, for the incisions to alternate between incisions at a distance from one another and incisions immediately behind one another.

In one advantageous embodiment of the invention the incisions are formed by a train of sections made up of sections preferably of equal length and joining n points to one another, it being possible for n to be between 1 and infinity. With further preference the angles between the individual sections are likewise all of the same magnitude.

The following values for n have proved to be particularly advantageous:
is equal to 1, so that the incision has the form of an isosceles triangle,
n is equal to 2, so that the incision has the form of a trapezium,
n is equal to 3, so that the incision has the form of a half-octagon, or
n is equal to infinity, so that the incision has the form of a curve, in particular the form of a semicircle.

Arranged in a row, the incisions may produce a preferably regular corrugated form without, or with only short, linear regions between points and bases of each individual incision, producing a profile which is similar to a sinusoidal curve, for example.

The serration employed preferably is composed of a sequence of serrate notches which in one advantageous embodiment are identical and which are present on at least one of the long edges of the adhesive tape. The notches may in particular be rounded off at the point protruding into the backing of the adhesive tape, in other words, have a radius. This is of course also true for the outwardly pointing points between the individual notches, which can also be rounded off.

With this very regular cut-edge profile, all of the maxima and all of the minima, respectively, are at the same distance from the center of the backing.

In another advantageous embodiment of the invention the incisions are formed by forming the edge itself at regular intervals from a train of sections made up of sections preferably of equal length and joining n points to one another, it being possible for n to be between 1 and infinity, so that in the edge region there remain semi-ellipses, trapeziums or triangles pointing away from the backing's center, and the areas situated between them are cut out or punched out. With further preference, here as well, the angles present between the individual sections are likewise all of the same size.

Although the zigzag cut already solves the stated problem very effectively, there may under certain conditions be a transfer of adhesive from the edges of the tape, applied to a surface, to other surfaces which lie on the tape or are moved over it. The surfaces thus contaminated with adhesive then lead to disruptions in downstream operations, such as the printing operation, for example. In industrial mass production, such as the printing of cardboard packaging, for example, this can lead to the economically disadvantageous production of reject product and to sensitive plant downtime.

The cause of the above-described transfer of adhesive is that during the slitting operation that leads to the zigzag cut the adhesive is not always separated off entirely flush with the backing of the adhesive tape. Depending on the mode of construction of the blades, the slitting regime and also the application regime, it is possible, after the slitting operation, for a greater or lesser amount of adhesive to protrude beyond the edge of the backing or even to be smeared onto the lateral margin of the adhesive-tape backing. At the tips of the zigzags, these regions of adhesive are, for geometric reasons, attached significantly less strongly to adjacent regions of adhesive. Particularly in the case of a low-cohesion adhesive, on the one hand, and particularly high mechanical stress as a result of an article rubbing on the applied adhesive tape or lying on the adhesive tape, on the other hand, it may happen that the adhesive becomes detached from the tips and/or sides of the zigzags and is transferred to the surface of the rubbing article.

This problem is completely eliminated if, instead of progressive zigzags in triangular form, more or less pointed, there are provided, instead, either round convexities and concavities (synonymous with corrugation) or else linear concavities having one or two or more, more or less obtuse angles to the corners.

As the principle of action it is possible to consider, on the one hand, a reduction in the shearing load on the adhesive at the exposed places on the edges during slitting, and on the other hand a reduction in the lateral extrusion of the adhesive during or after the application of the adhesive tape.

In another advantageous embodiment of the invention the incisions are formed by cuts which extend from the edge of the adhesive tape, in the direction of the center of the backing material, each cut severing at least one filament aligned substantially parallel to the cut edge.

The cuts may extend linearly, in which case the angle that can be chosen between cut and edge of the adhesive tape is arbitrary. Preference is given to cuts which extend in transverse direction, i.e. form a right angle with the edge.

Furthermore, the cuts may have any desired regular or irregular curve profile.

The frequency of the incisions/notches is preferably at least 1/30 cm, preferably at least ⅕ cm, very preferably at least 1/cm. Furthermore, advantageous variants have proved to be those where 10 to 30/cm, preferably 15 to 25/cm incisions/notches are present, it being possible for the notches likewise to be disposed irregularly and to be of differing depth.

In one further advantageous embodiment of the invention there are incisions/notches which have a depth of 15 to 100 μm, the incisions further preferably all having the same depth.

On the basis of the properties outlined, the adhesive tape of the invention can be used for bundling, packaging and palletizing. It is particularly suitable, furthermore, as a reinforcing tape on films or paper, corrugated board or solid board, preferably at exposed positions such as grips, handles and cut-outs.

To produce the incisions it is possible to utilize all commercially customary cutting, slitting or punching methods which carry the required precision and/or are suitable for the introduction of incisions with the desired spacing. Furthermore, the use of lasers is becoming increasingly significant.

### BRIEF DESCRIPTION OF THE DRAWINGS

The invention will now be described in greater detail with reference to the drawings, wherein:

FIG. 1 is a depiction of a crush cutting knife;

FIG. 2 is a enlargement of a section of the teeth of the crush cutting knife shown in FIG. 1;

FIGS. 3a-3c all depict various incisions made in at least one edge of an adhesive tape; and

FIG. 4 depicts various patterns cut in at least one edge of an adhesive tape.

In one advantageous embodiment, a serration is produced by the method which is explained below:

For the longitudinal slitting of the adhesive-coated film web rotating crush cutting knives which are designed in terms of their cutting geometry as zigzag knives, are used (samples c to f). Samples a and b correspond to reference films having a straight side edge, the cutting having been carried out using S- or Q-section.

| | |
|---|---|
| Zigzag knife height | 0.2 mm |
| Number of teeth: | 604 |
| Cutting phase angle: | 90° |
| Tooth width: | 0.2 mm |
| Cutting face width: | <0.05 mm |

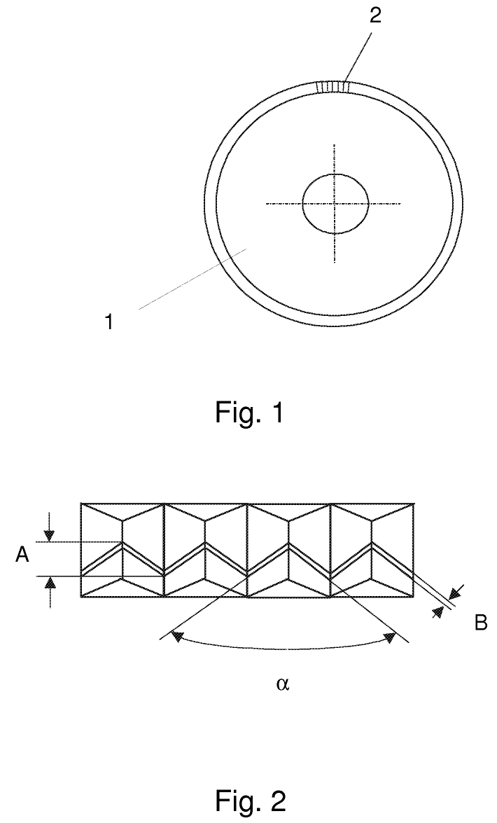

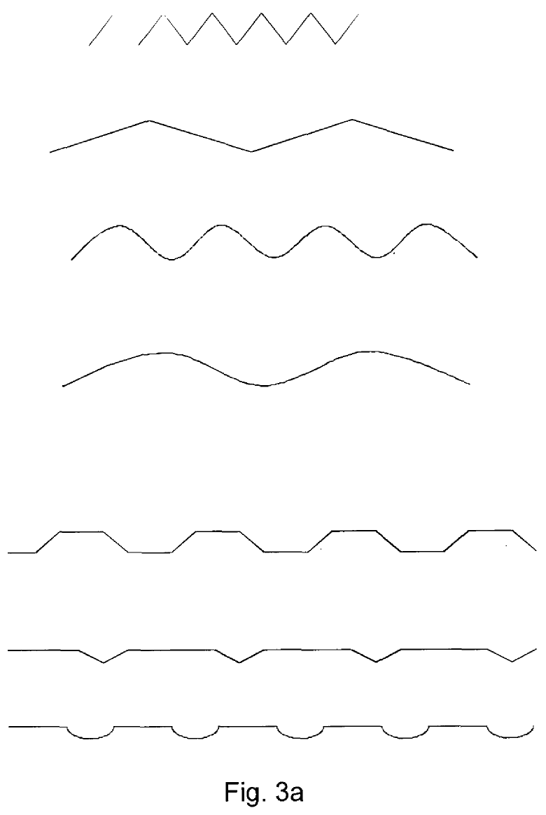

FIGS. 1 and 2 show the crush cutting knife 1 used. The knife 1 has 604 teeth 2. The cutting phase angle α is 90°. The tooth width A is shown in the table below; the cutting face width B is less than 0.05 mm.

| | | Ultimate | |
|---|---|---|---|
| | | tensile stress | |
| | | strength | Breaking extension |
| Sample | Tooth width A | [N/cm] | [%] |
| a | Slit cut | 273 | 5.3 |
| b | Crush cut | 276 | 5.4 |
| c | Serrations 1 mm | 270 | 5.2 |
| d | Serrations 0.5 mm | 273 | 5.3 |
| e | Serrations 0.2 mm | 278 | 5.3 |
| f | Serrations 2.2 mm | 235 | 5.2 |

The results set out in the table demonstrate that the mechanical properties, such as breaking elongation and ultimate tensile stress strength, are retained almost completely in spite of the weakening of the backing material as a result of the serration. At the same time, as a result of the notches in the lengthwise edge, which in this case sever not more than one filament aligned substantially parallel to the cut edge, the pullout of very long fibers is avoided; such pullouts could disrupt the operation of machine processing of the adhesive tape.

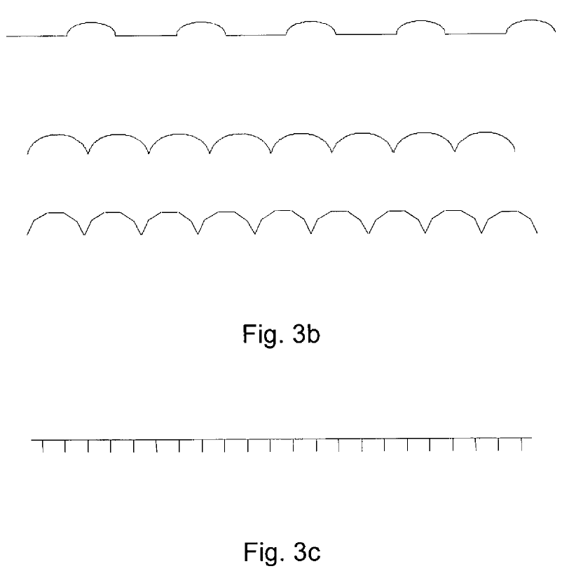

FIG. 3a shows a variety of embodiments with the geometry of the incisions in at least one edge of the adhesive tape. The incisions are characterized in that, at regular intervals, mathematic figures such as triangles, trapeziums or semi-ellipses are cut out or punched from the backing.

The first cut pattern represents the so-called serrated cut.

In another embodiment of the invention, as per FIG. 3b, the incisions are formed by leaving the mathematical figures such as triangles, trapeziums or semi-ellipses in the edge region and cutting out or punching out the areas located in between them.

FIG. 3c shows an embodiment in which the incisions are formed by cuts which extend from the edge of the adhesive tape in the direction of the center of the backing material, specifically in the transverse direction of the adhesive tape. The cuts form a right angle with the edge.

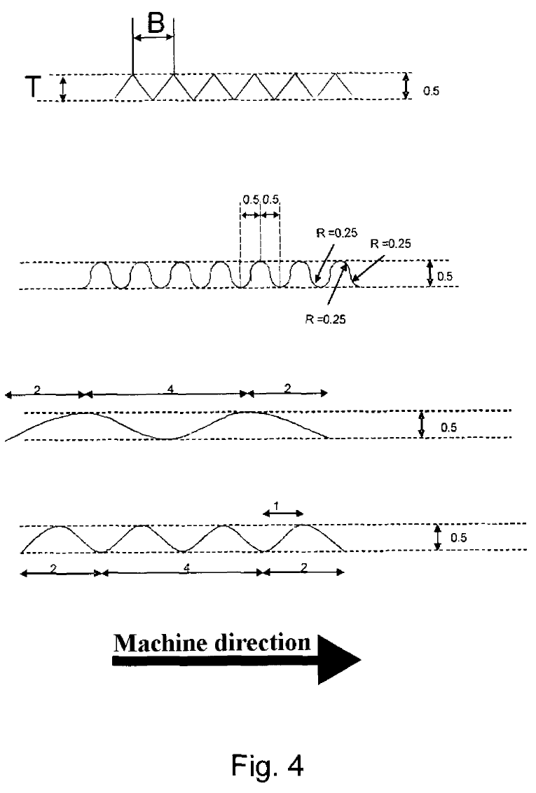

Patterns, shown in FIG. 4, in the edge of the adhesive tape have proved to be particularly advantageous. In each case the edge of an adhesive tape 19 mm wide is shown. All of the numerical data in FIG. 4 are in millimeters.

What is claimed is:

1. An adhesive tape comprising a backing material and an adhesive applied to at least one side of said backing, the adhesive tape in a lengthwise direction being reinforced by integrated or added fibers or filaments, wherein the adhesive tape on at least one long edge has incisions, the incisions severing per long edge at least one filament aligned substantially parallel to a cut edge.

2. Adhesive tape according to claim 1, wherein the individual filaments are continuous filaments and/or have a linear density of between 4 and 8 dtex.

3. Adhesive tape according to claim 1, wherein the individual filaments are disposed in one parallel alignment or at most in three parallel alignments.

4. Adhesive tape according to claim 1, wherein the individual filaments are composed of glass fibers or carbon fibers, polyester fibers, polypropylene fibers, polyethylene fibers, polyamide fibers and/or aramid fibers.

5. Adhesive tape according to claim 1, comprising between 1 and 30 filaments per centimeter width in the backing material.

6. Adhesive tape according to claim 1, wherein the backing material is reinforced by an open filament fabric.

7. Adhesive tape according to claim 1, wherein the backing material has a thickness of 10 to 100 μm.

8. Adhesive tape according to claim 1, wherein the adhesive is applied to the backing material in an amount between 30 to 100 g/m².

9. Adhesive tape according to claim 1, wherein the incisions are formed by a train of sections made up of sections of equal or different length and joining n points to one another, it being possible for n to be between 1 and infinity.

10. Adhesive tape according to claim 9, wherein
n is equal to 1, so that the incision has the form of an isosceles triangle,
n is equal to 2, so that the incision has the form of a trapezium,
n is equal to 3, so that the incision has the form of a half-octagon, or
n is equal to infinity, so that the incision has the form of a curve.

11. Adhesive tape according to claim 1, wherein the incisions are formed by forming the edge itself at regular intervals from a train of sections made up of sections of equal or different length and joining n points to one another, it being possible for n to be between 1 and infinity, so that the areas situated between them are cut out or punched out.

12. Adhesive tape according to claim 1, wherein the incisions are formed by cuts which extend from the edge of the adhesive tape in the direction of the center of the backing material, each cut severing at least one filament aligned substantially parallel to the cut edge.

13. Adhesive tape according to claim 1, wherein the incisions are at a distance from one another or immediately behind one another or alternate between being at a distance from one another and immediately behind one another.

14. Adhesive tape according to claim 1, wherein the incisions are arranged such that an edge profile of the adhesive tape is zigzag or adopts the form of a sinusoidal curve.

15. Adhesive tape according to claim 1, wherein the incisions all have the same depth.

16. An method for bundling, packaging and palletizing, which comprises bundling, packaging or palletizing with an adhesive tape according to claim 1.

17. A method of reinforcing film, paper, corrugated board or solid board, which comprises applying an adhesive tape according to claim 1 to said film, paper, corrugated board or solid board.
